(19) United States
(12) Patent Application Publication
(10) Pub. No.: US 2014/0209417 A1
(43) Pub. Date: Jul. 31, 2014

(54) BRAKE STRUCTURE FOR HOIST

(71) Applicant: Xiu-Feng Chen, Taichung City (TW)

(72) Inventor: Xiu-Feng Chen, Taichung City (TW)

(21) Appl. No.: 13/753,562

(22) Filed: Jan. 30, 2013

(51) Int. Cl. F16D 55/02

(52) U.S. Cl. CPC F16D 55/025
USPC 188/71.5

(57) ABSTRACT

The invention includes a passive shaft, having a first gear and an outer thread; a fixed disc, being axially passed through by the passive shaft, having a sleeve located at a center thereof; a ratchet, being a hollow body around the sleeve, and having two friction discs separately on two opposite sides thereof, wherein a first bearing is put around the sleeve and sandwiched between the fixed disc and the ratchet; a second gear, having an inner thread screwed onto the outer thread and an annular wall at a center thereof, wherein a second bearing is received in the annular wall and sandwiched between the second gear and the ratchet; and a pushing disc, movably put around the annular wall, and sandwiched between the ratchet and the second gear.

### BACKGROUND OF THE INVENTION

1. Technical Field The invention relates to hoists, particularly to brakes used in hoist.

2. Related Art

A conventional hoist brake structure, as shown in FIGS. 4 and 5, uses a motor to drive a transmission mechanism. The transmission mechanism includes a transmission shaft 21 and a passive shaft 30. The transmission shaft 21 is provided with a first gear 22 and a second active gear 23. The passive shaft 30 is disposed on the transmission shaft 21 and is provided with a first passive gear 31 engaging with the first gear 22. The passive shaft 30 is formed with an outer thread 32 on which a second passive gear 33 is screwed. The second passive gear 33 engages with the second active gear 23. A pushing disc 34 is mounted on the first passive gear 31 and rotates with the passive shaft 30. A ratchet 35 is disposed between the pushing disk 34 and the second passive gear 23. Two opposite sides of the pushing disk 34 are separately mounted by two friction disks 351.

When using the hoist to lift something, the ratchet 35 will rotate with the passive shaft 30 and the second passive gear 33 will rotate with the second active gear 23. When the hoist does not have enough power or is stopped, the load on the hook will pull down to reverse the transmission shaft. As shown in FIGS. 4 and 6, the second passive gear 33 reversely rotates with the second active gear 23, but the ratchet 35 is stopped by the pawl 36. At this time, the second passive gear 33 rotates toward the ratchet 35 and progressively tightens up, so that the ratchet 35 is clamped by the pushing disc 34 and the second passive gear 33 to be braked.

However, if the hoist continues to lift the load, torque from the motor must exceed the friction from the ratchet 35 being clamped by the pushing disc 34 and the second passive gear 33. The ratchet 35 will make noises and vibrations while the motor torque is exceeding the friction. The vibrations are dangerous because may cause the lifted load to sway.

Additionally, because the second passive gear 33 is screwed onto the passive shaft 30 and the gap between the threads is very large, the second passive gear 33 will rock or deflect and the frictional area between the second passive gear 33 and the ratchet 35 will be reduced. This will cause another risk.

Furthermore, the ratchet 35 is put around the pushing disk 34 and the gap therebetween is large, too. Such a gap will also cause rock or even cause the ratchet 35 to be jammed on the pushing disc 34 and finally the brake malfunctions.

### SUMMARY OF THE INVENTION

An object of the invention is to provide a brake structure for a hoist, which can eliminate vibration, rock or sway to effectively avoid risk.

The brake structure of the invention includes a passive shaft, having a first gear and an outer thread; a fixed disc, being axially passed through by the passive shaft, having a sleeve located at a center thereof; a ratchet, being a hollow body around the sleeve, and having two friction discs separately on two opposite sides thereof, wherein a first bearing is put around the sleeve and sandwiched between the fixed disc and the ratchet; a second gear, having an inner thread screwed onto the outer thread and an annular wall at a center thereof, wherein a second bearing is received in the annular wall and sandwiched between the second gear and the ratchet; and a pushing disc, movably put around the annular wall, and sandwiched between the ratchet and the second gear.

### BRIEF DESCRIPTION OF THE DRAWINGS

FIG. 1 is an exploded view of the invention;

FIG. 2 is a cross-sectional view of the invention in a free status;

FIG. 3 is a cross-sectional view of the invention in a braking status;

FIG. 4 is a cross-sectional view of a conventional hoist brake;

FIG. 5 is a cross-sectional view of a conventional hoist brake in a free status; and

FIG. 6 is a cross-sectional view of a conventional hoist brake in a braking status.

### DETAILED DESCRIPTION OF THE INVENTION

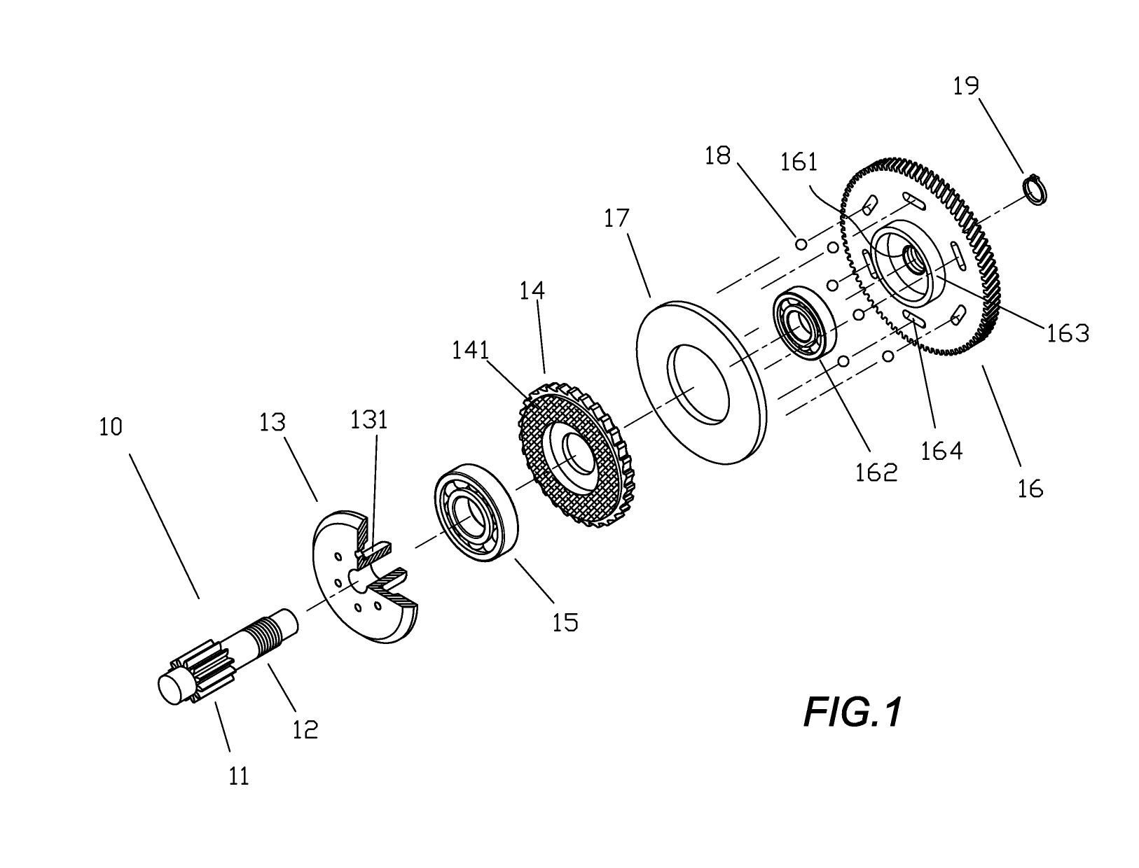

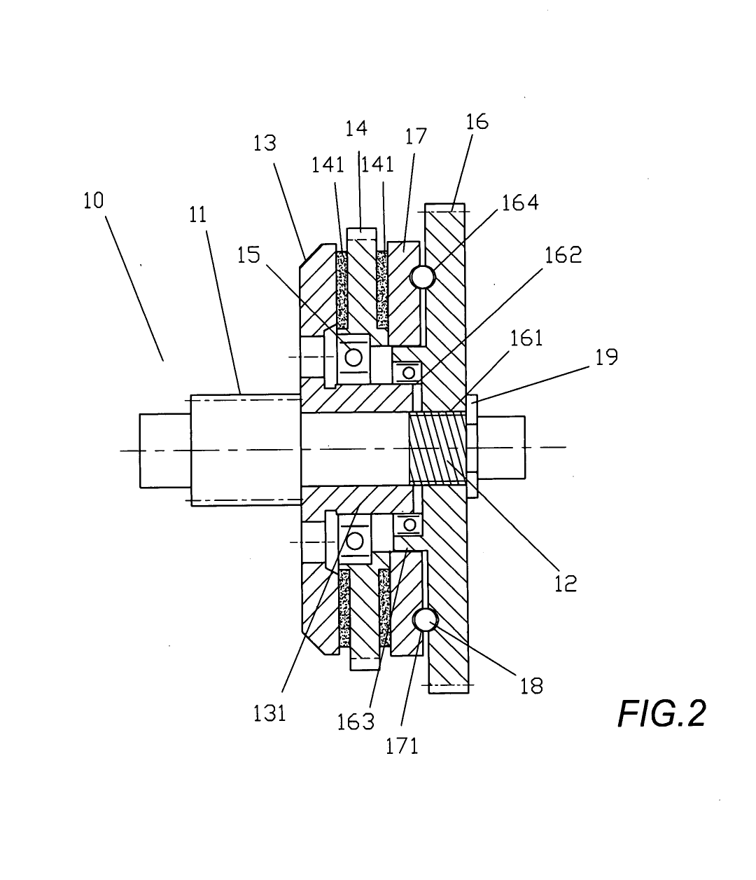

Please refer to FIGS. 1 and 2. The brake structure of the invention includes a passive shaft 10, a fixed disc 13, a ratchet 14, a second gear 16 and a pushing disc 17. The passive shaft 10 has a first gear 11 and an outer thread 12. The fixed disc 13 is axially passed through by and firmly fixed on the passive shaft 10 and has a sleeve 131 located at a center thereof. Preferably, the fixed disc 12 is secured on the passive shaft 10 by welding. The ratchet 14 is a hollow body around the sleeve 131. Two friction discs 141 are separately attached on two opposite sides the ratchet 14. A first bearing 15 is put around the sleeve 131 and sandwiched between the fixed disc 13 and the ratchet 14. The second gear 16 has an inner thread 161 on a central hole thereof. The inner thread 161 is screwed onto the outer thread 12. The second gear 16 is further formed with an annular wall 163 at a center thereof. The annular wall 163 encompasses the central hole. A second bearing 162 is received in the annular wall 163 and sandwiched between the second gear 16 and the ratchet 14. The pushing disc 17 is movably put around the annular wall 163 and sandwiched between the ratchet 14 and the second gear 16. Two corresponding sides of the second gear 16 and the pushing disc 17 are formed with a plurality of hemispheric cavities 164, 171. Every two corresponding hemispheric cavities 164, 171 form a spherical room to receive a steel ball 18. A fastener ring 19 is put around the passive shaft 10 to abut against the second gear 16 for preventing the second gear 16 from escaping.

Please refer to FIG. 2. Because the first bearing 15 is sandwiched between the fixed disc 13 and the ratchet 14, the gap between the ratchet 14 and the fixed disc 13 can be reduced and the ratchet 14 can be stably supported without rock. As a result, the ratchet 14 can stably rotate and does not jam.

As shown in FIG. 2, the second bearing 162 is received in the annular wall 163 and put around the sleeve 131 of the fixed disc 13. That is to say, the second bearing 162 is sandwiched between the annular wall 163 and the sleeve 131. This can reduce the gap between the annular wall 163 and the sleeve 131, so that the second gear 16 can be axially moved and the second fear 16 can be firmly secured on and rotated with the passive shaft 10. The second gear 16 will not rock.

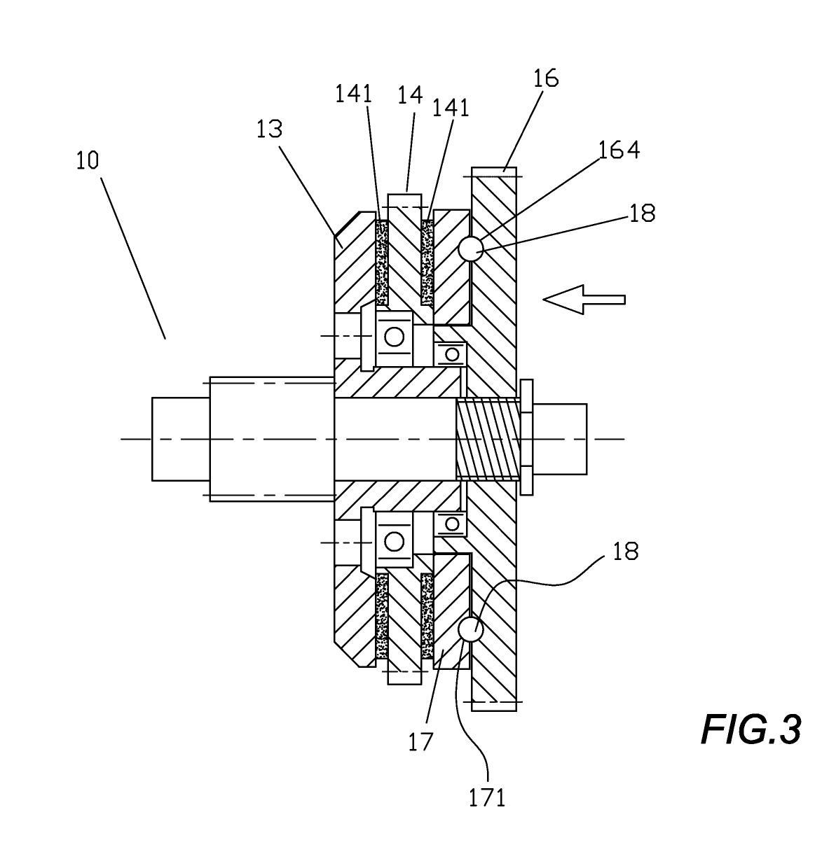

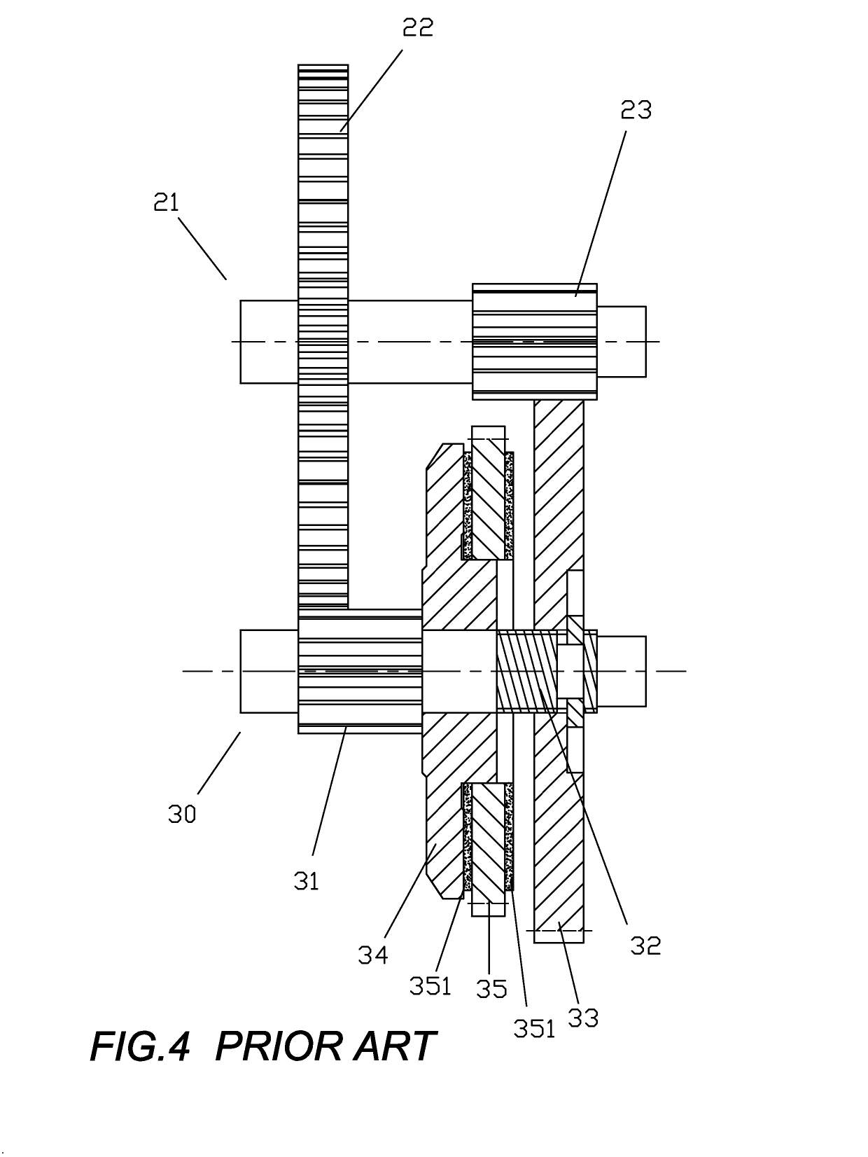

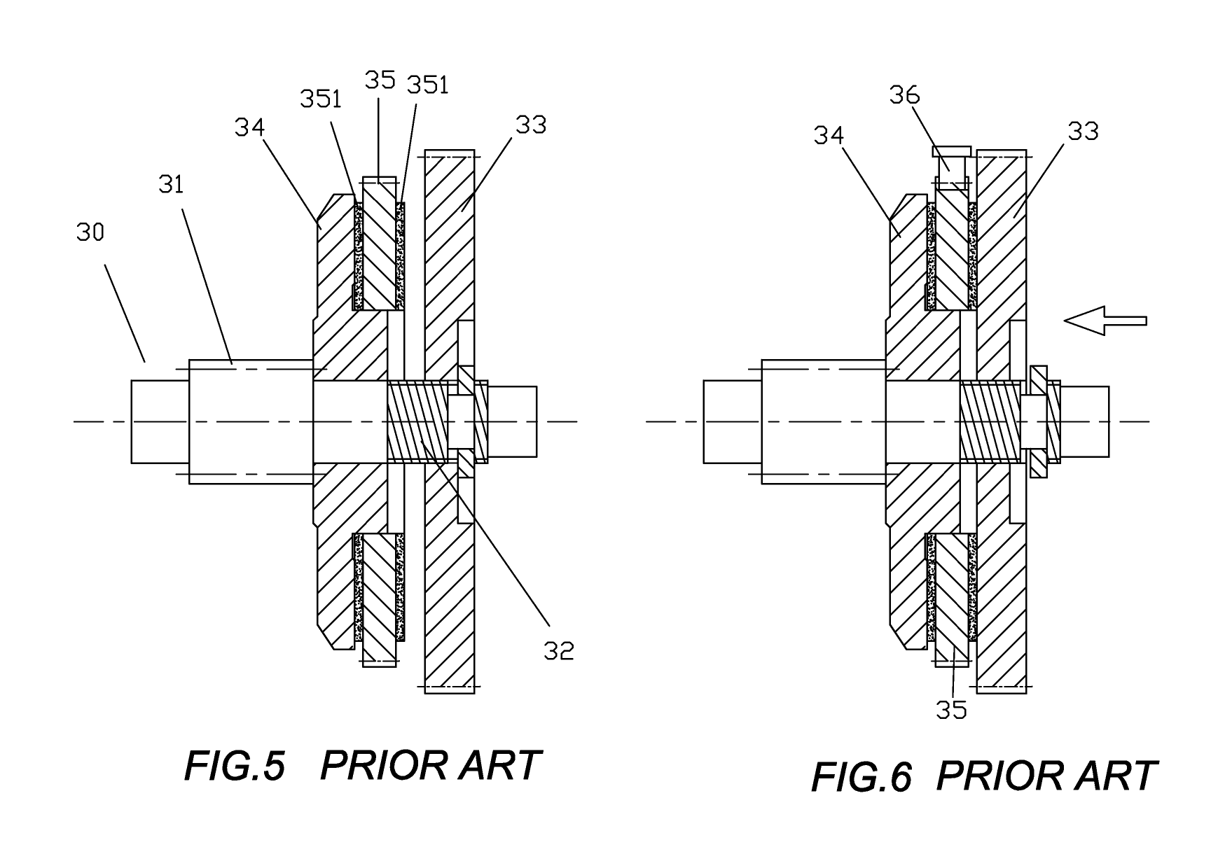

Please refer to FIGS. 2 and 3. When the second gear 16 axially pushes the ratchet 14, the pushing disc 17 and the fixed disc 13 will clamp the friction discs 141 on the ratchet 14 and stop the passive shaft 10 from rotating. At the same time, the pushing disc 17 and the second gear 16 also approach each other to clamp the steel balls 18. The friction between the pushing disc 17 and the friction discs 141 is greater than the clamping force of the steel balls 18, so the second gear 16 will lose pressure onto the steel balls 18 and the steel balls 18 will re-rotate to make a release when the hoist is restarted. Thus, the hoist can be smoothly restarted without vibrations.

While the forgoing is directed to a preferred embodiment of the present invention, other and further embodiments of the invention may be devised without departing from the basic scope thereof. As such, the appropriate scope of the invention is to be determined according to the claims.

1. A brake structure for a hoist, comprising:
a passive shaft, having a first gear and an outer thread;
a fixed disc, being axially passed through by and fixed on the passive shaft, having a sleeve located at a center thereof;
a ratchet, being a hollow body around the sleeve, and having two friction discs separately on two opposite sides thereof, wherein a first bearing is put around the sleeve and sandwiched between the fixed disc and the ratchet;
a second gear, having an inner thread screwed onto the outer thread and an annular wall at a center thereof, wherein a second bearing is received in the annular wall and sandwiched between the second gear and the ratchet; and
a pushing disc, movably put around the annular wall, and sandwiched between the ratchet and the second gear.

2. The brake structure of claim 1, wherein two corresponding sides of the second gear and the pushing disc are formed with a plurality of hemispheric cavities, and every two corresponding hemispheric cavities form a spherical room to receive a steel ball.

3. The brake structure of claim 1, wherein the second bearing is sandwiched between the annular wall and the sleeve.

4. The brake structure of claim 1, further comprising a fastener ring around the passive shaft, and abutting against the second gear.
